(19) United States
(12) Patent Application Publication
(10) Pub. No.: US 2016/0362343 A1
(43) Pub. Date: Dec. 15, 2016

(54) Device for harmless treatment of poultry

(71) Applicant: Bioland Environmental Technologies Group Corp. Ltd. (Beijing Branch), Beijing (CN)

(72) Inventors: Junying Shi, Beijing (CN); Zejun Huang, Beijing (CN); Zhenhuan Zhao, Beijing (CN); Yichao Ping, Beijing (CN)

(73) Assignee: Bioland Environmental Technologies Group Corp. Ltd. (Beijing Branch)

(21) Appl. No.: 15/212,252

(22) Filed: Jul. 17, 2016

(30) Foreign Application Priority Data
Jul. 17, 2015 (CN) 201520524778.2

(51) Int. Cl. C05F 1/02; C05F 17/02; A22B 7/00; C05F 1/00

(52) U.S. Cl. CPC C05F 1/02; C05F 1/005; C05F 17/0258; A22B 7/001; A22B 7/008

(57) ABSTRACT

A device for harmless treatment of poultry includes: a feeder, a crusher, a chemical manufacturing device, a solid-liquid separating equipment, a dryer, an oil-water separating equipment and a water treatment device. The device for harmless treatment of poultry of the present invention accomplishes harmless treatment of poultries in a real sense. By repeatedly experiments and improvements in recent years, the device of the present invention has various advantages of automated treatment, non-polluting treatment process, environmental protection and harmless treatment results, and recyclable and high utilization products.

### CROSS REFERENCE OF RELATED APPLICATION

The present application claims priority under 35 U.S.C. 119(a-d) to CN 201520524778.2, filed Jul. 17, 2015.

### BACKGROUND OF THE PRESENT INVENTION

Field of Invention

The present invention relates to the field of an animal carcass technique, and more particularly to a device for harmless treatment of poultry.

Description of Related Arts

In the conventional arts, the carcasses of animals died from diseases are mainly treated by burial or incineration. Since the carcasses of animals died from diseases carry pathogens, adopting the burial or incineration treatment not only causes serious environmental pollution problems, but also may cause major animal disease outbreaks, so that the security of livestock production is endangered and even serious public health events are caused. Thus, the harmless treatment of animals is of significant importance. There are small amounts of poultry harmless treatment devices in the conventional arts, but the conventional animal harmless treatment devices generally have shortcoming of complicated structures, high costs and limited harmless treatment effects, and thus wide application thereof is limited.

### SUMMARY OF THE PRESENT INVENTION

In view of the shortcomings in the conventional arts mentioned above, the present invention provides a device for harmless treatment of poultry.

A technical solution of the present invention is as follows.

The present invention provides a device for harmless treatment of poultry, comprises:
a feeder, a crusher, a chemical manufacturing device, a solid-liquid separating equipment, a dryer, an oil-water separating equipment and a water treatment device;
wherein a discharge opening of the feeder is connected with a feed opening of the crusher via a first screw conveyer;
a discharge opening of crusher is connected with a feed opening of the chemical manufacturing device via a second screw conveyer;
a discharger opening of the chemical manufacturing device is connected with a feed opening of the solid-liquid separating device;
a solid discharge opening and a liquid discharge opening are provided on the solid-liquid separating equipment, wherein the solid discharge opening is connected with a feed opening of the dryer via a third screw conveyer, the liquid discharge opening is connected with a liquid inlet of the oil-water separating device via a conveying pipe;
an oil discharge opening of the oil-water separating equipment is connected with a liquid feed opening of an oil storage tank; and
a water discharge opening of the oil-water separating equipment is connected with a water inlet of the water treatment device.

Preferably, the chemical manufacturing device comprises: a shell which is hollow and sealed, wherein a stirring shaft is perpendicularly provided in the shell, a plurality of vanes which are distributed in a shape of a spiral are fixedly provided on the stirring shaft, wherein a periphery of each vane is a cutting edge; the stirring shaft interacts with s driving motor provided on an external of the shell; driven by the driving motor, the stirring shaft rotates, so as to drive the canes to rotate;
a feed inlet is provided on a left and upper portion of the shell, and a discharge opening is provided on a right and lower portion of the shell, a jacket is provide on an external of the shell, and a steam feed opening and a steam discharge opening are provided on the jacket, wherein the steam feed opening and the steam discharge opening is communicated with a heat exchanger outside the shell; and furthermore, a plurality of steam discharge holes for injecting saturated steam to a cavity of the shell are evenly provided on the jacket;
a support frame is rotatablely provided on a bottom portion of the shell, and a tilt motor is fixedly provided on the support frame; driven by the tilt motor, the shell inclines to accomplish discharge.

Preferably, the stirring shaft is a cavity structure, a steam feed end portion of the stirring shaft is communicated with a steam inlet outside the stirring shaft, and a plurality of steam discharge outlets for injecting saturated steam to the cavity of the shell are provided on the stirring shaft.

Preferably, a vent valve is provided on the shell of the chemical manufacturing device, and the vent valve communicates with purification equipment of waste water and waste gas via a discharge duct.

The device for harmless treatment of poultry provided by the present invention has beneficial effects as follows.

The device for harmless treatment of poultry of the present invention accomplishes harmless treatment of poultries in a real sense. By repeatedly experiments and improvements in recent years, the device of the present invention has various advantages such as automated treatment, non-polluting treatment process, environmental protection and harmless treatment results, and recyclable and high utilization products.

### BRIEF DESCRIPTION OF THE DRAWINGS

FIG. 1 is a structural sketch view of a device for harmless treatment of poultry according to a preferred embodiment of the present invention.

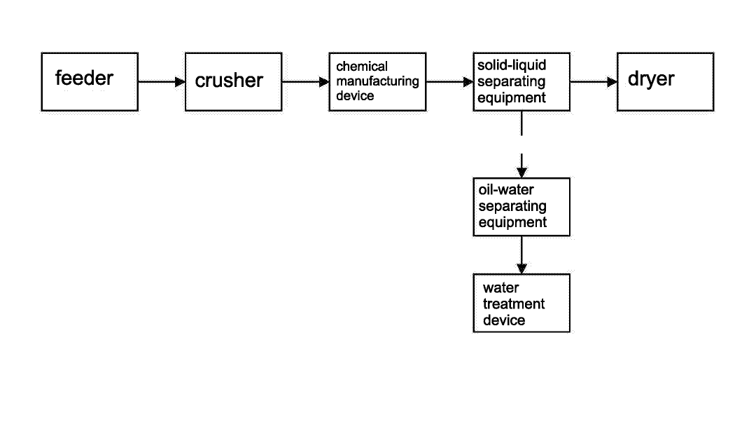

### DETAILED DESCRIPTION OF THE PREFERRED EMBODIMENT

These and other objectives, features, and advantages of the present invention will become apparent from the following detailed description, the accompanying drawings, and the appended claims.

Referring to the FIGURE, the present invention provides a device for harmless treatment of poultry, comprises:
a feeder, a crusher, a chemical manufacturing device, a solid-liquid separating equipment, a dryer, an oil-water separating equipment and a water treatment device;
wherein a discharge opening of the feeder is connected with a feed opening of the crusher via a first screw conveyer;
a discharge opening of crusher is connected with a feed opening of the chemical manufacturing device via a second screw conveyer;
a discharger opening of the chemical manufacturing device is connected with a feed opening of the solid-liquid separating device;
a solid discharge opening and a liquid discharge opening are provided on the solid-liquid separating equipment, wherein the solid discharge opening is connected with a feed opening of the dryer via a third screw conveyer, the liquid discharge opening is connected with a liquid inlet of the oil-water separating device via a conveying pipe;
an oil discharge opening of the oil-water separating equipment is connected with a liquid feed opening of an oil storage tank; and
a water discharge opening of the oil-water separating equipment is connected with a water inlet of the water treatment device.

The chemical manufacturing device, which is a key device of the device for harmless treatment of poultry, is a device for performing high temperature and high pressure sterilization on animal carcass.

In an improvement, the chemical manufacturing device comprises: a shell which is hollow and sealed, wherein a stirring shaft is perpendicularly provided in the shell, a plurality of vanes which are distributed in a shape of a spiral are fixedly provided on the stirring shaft, wherein a periphery of each vane is a cutting edge; thus, when stirring the carcass of poultries, the device further has cutting and smashing effects on animal carcess, so as to improve sterilization efficiency on animal carcass;
the stirring shaft interacts with s driving motor provided on an external of the shell; driven by the driving motor, the stirring shaft rotates, so as to drive the canes to rotate, so as to drive the canes to rotate, and the high-speed rotating vanes stirs to smash animal carcass while cutting animal carcass further;
a feed inlet is provided on a left and upper portion of the shell, and a discharge opening is provided on a right and lower portion of the shell, a jacket is provide on an external of the shell, and a steam feed opening and a steam discharge opening are provided on the jacket, wherein the steam feed opening and the steam discharge opening is communicated with a heat exchanger outside the shell; and furthermore, a plurality of steam discharge holes for injecting saturated steam to a cavity of the shell are evenly provided on the jacket.

A support frame is rotatablely provided on a bottom portion of the shell, and a tilt motor is fixedly provided on the support frame; driven by the tilt motor, the shell inclines to accomplish discharge. The design has effects as follows. In order to simplify the structure of the chemical manufacturing device and improve the sealing performance thereof as well, the chemical manufacturing device is not equipped with individual solid discharge opening and liquid discharge opening, but all materials after treatment of the chemical manufacturing device are discharged to a solid-liquid device. In the present invention, the shell is a reversible structure. Thus, after the chemical manufacturing process, under the effects of the tilt motor, all the materials are discharged to the solid-liquid separating device automatically and in a high efficiency, so as to shorten an entire time of the harmless treatment process.

In addition, in order to improve the sterilization effects of the animal carcass in the chemical manufacturing device, the stirring shaft is a cavity structure, a steam feed end portion of the stirring shaft is communicated with a steam inlet outside the stirring shaft, and a plurality of steam discharge outlets for injecting saturated steam to the cavity of the shell are provided on the stirring shaft.

Furthermore, a vent valve is provided on the shell of the chemical manufacturing device, and the vent valve communicates with purification equipment of waste water and waste gas via a discharge duct. The waste gas discharged by the chemical manufacturing device is purified by the waste water and waste gas discharge duct, so as to prevent causing environmental pollution.

Working principle of the device for harmless treatment of poultry carcass is as follows.

The animal carcass is conveyed into the crusher, crushed by the crusher and then conveyed into the chemical manufacturing device. In the chemical manufacturing device, the animal carcass is performed with complete sterilization under high temperature and high pressure. In the chemical manufacturing device, after the sterilization, solid-liquid mixture is obtained. Then the solid-liquid mixture is discharged to a solid-liquid separating device, wherein the solid-liquid device can adopt a disc-centrifuge. The solid-liquid mixture is separated by the disc-centrifuge. After separation, the solid material is conveyed to a dryer for a drying treatment, and bone and meat powder is obtained. The bone and powder can serve as a raw material of high-protein feed and organic fertilizer. The liquid material after separation is oil-water mixture. The oil-water mixture is conveyed to an oil-water separation device and separated to water and oil. The the separated water is purified by a water treatment device and recycled. The separated oil can be utilized for industrial oil, feed oil and biodiesel.

Thus, the device for harmless treatment of poultry of the present invention accomplishes harmless treatment of poultries in a real sense. By repeatedly experiments and improvements in recent years, the device of the present invention has various advantages such as automated treatment, non-polluting treatment process, environmental protection and harmless treatment results, and recyclable and high use products. The device of the present invention has received attention and praise of the majority of users.

The device for harmless treatment of poultry of the present invention has advantages as follows.

(1) The whole treatment process of performed in a sealed state, and thus no secondary pollution is ensured.

(2) The general international steam is utilized without other energy consumption, which is cost effective.

(3) The shell of the chemical manufacturing device is manufactured according to national standard of boiler and pressure vessel, and has good corrosion resistance and pressure-bearing performance.

(4) The chemical manufacturing device can be equipped with door safety interlock system, safety valve, pressure controller and other safety device, and has reliable and safe performance.

(5) The chemical manufacturing device has large heating area, and fast temperature elevation, which is capable of shortening wet time and save energy.

(6) The device of the present invention can adopt BOT mode for operating. In addition, the device of the present invention can combine with kitchen garbage device in a kitchen garbage treatment plant, so as to achieve a combining treatment of rubbish, and the specific process is as follows:

(6-a) combining the waste water generated in the harmless treatment of dead animals with kitchen waste water, and a separate treatment station is not needed;

(6-b) combining solid waste generated during the harmless treatment of dead animals with the kitchen waste to perform anaerobic fermentation, and methane generated is capable of providing heat for the dryer; and (6-c) combining crude oil generated during the harmless treatment of dead animals with kitchen waste oil, so as to treat to produce lubricating oil or biodiesel.

By the manner mentioned above, optimization of investment and operating costs is accomplished, so as to achieve a win-win effects of economic and social benefits.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A device for harmless treatment of poultry, comprising: a feeder, a crusher, a chemical manufacturing device, a solid-liquid separating equipment, a dryer, an oil-water separating equipment and a water treatment device;
wherein a discharge opening of the feeder is connected with a feed opening of the crusher via a first screw conveyer;
a discharge opening of the crusher is connected with a feed opening of the chemical manufacturing device via a second screw conveyer;
a discharger opening of the chemical manufacturing device is connected with a feed opening of the solid-liquid separating device;
a solid discharge opening and a liquid discharge opening are provided on the solid-liquid separating equipment, wherein the solid discharge opening on the solid-liquid separating equipment is connected with a feed opening of the dryer via a third screw conveyer, the liquid discharge opening is connected with a liquid inlet of the oil-water separating device via a conveying pipe;
an oil discharge opening of the oil-water separating equipment is connected with a liquid feed opening of an oil storage tank; and
a water discharge opening of the oil-water separating equipment is connected with a water inlet of the water treatment device.

2. The device for harmless treatment of poultry, as recited in claim 1, wherein the chemical manufacturing device comprises: a shell which is hollow and sealed, wherein a stirring shaft is perpendicularly provided in the shell, a plurality of vanes which are distributed in a shape of a spiral are fixedly provided on the stirring shaft, wherein a periphery of each vane is a cutting edge; the stirring shaft interacts with s driving motor provided on an external of the shell; driven by the driving motor, the stirring shaft rotates, so as to drive the canes to rotate;
a feed inlet is provided on a left and upper portion of the shell, and a discharge opening is provided on a right and lower portion of the shell, a jacket is provide on an external of the shell, and a steam feed opening and a steam discharge opening are provided on the jacket, wherein the steam feed opening and the steam discharge opening is communicated with a heat exchanger outside the shell; and furthermore, a plurality of steam discharge holes for injecting saturated steam to a cavity of the shell are evenly provided on the jacket;
a support frame is rotatablely provided on a bottom portion of the shell, and a tilt motor is fixedly provided on the support frame; driven by the tilt motor, the shell inclines to accomplish discharge.

3. The device for harmless treatment of poultry, as recited in claim 2, wherein the stirring shaft is a cavity structure, a steam feed end portion of the stirring shaft is communicated with a steam inlet outside the stirring shaft, and a plurality of steam discharge outlets for injecting saturated steam to the cavity of the shell are provided on the stirring shaft.

4. The device for harmless treatment of poultry, as recited in claim 2, wherein a vent valve is provided on the shell of the chemical manufacturing device, and the vent valve communicates with purification equipment of waste water and waste gas via a discharge duct.

5. The device for harmless treatment of poultry, as recited in claim 3, wherein a vent valve is provided on the shell of the chemical manufacturing device, and the vent valve communicates with purification equipment of waste water and waste gas via a discharge duct.
